(19) United States
(12) Patent Application Publication
(10) Pub. No.: US 2005/0232252 A1
(43) Pub. Date: Oct. 20, 2005

(54) Communication system with distributed intelligence

(76) Inventor: Thomas R. Hoover, Troutville, VA (US)

Correspondence Address: SETO PATENTS, 406 RIVERLAND DR., SALEM, VA, 24153, US

(21) Appl. No.: 11/069,253

(22) Filed: Mar. 1, 2005

Related U.S. Application Data
(60) Provisional application No. 60/548,622, filed on Mar. 1, 2004.

(51) Int. Cl. H04L 12/66

(52) U.S. Cl. 370/356

(57) ABSTRACT

A communications system with distributed intelligence thereby allowing easy expansion of the system while also providing a high degree of fault tolerance. The communications system allows for conversion, transmission and restoration of the human voice over a digital network. A telephone can be used as the input device for receiving the analog signal, or human voice. The telephone is also used to select a destination for the analog signal. The information is transmitted over the digital network and may also traverse through a private branch exchange and a wireless network before it arrives at its destination. At the destination the transmitted information is restored to an analog signal and played over one or more speakers. The present system is especially suited for use with an existing network.

The present invention was originally disclosed in U.S. provisional patent application Ser. No. 60/548,622 filed on Mar. 1, 2004, and priority is claimed to the provisional patent application.

### BACKGROUND OF THE INVENTION

The present invention relates generally to the field of communications systems and more specifically to a communications system with distributed intelligence.

Intercom and public address systems are well known in the field of communications. Intercom, or internal communications, systems are popular in large houses where they allow family members in different rooms to talk to each other, over direct wired systems. Public address, or PA, systems are often found in large warehouses where audio messages are played over speakers for all to hear. PA systems can be wired so that only selected speakers are used at any one time to broadcast a message. Intercom and PA systems both transmit and broadcast analog signals. Analog signals provide for a better reproduction of the human than digital signals. However, large analog networks are rare, thus the coverage area for analog intercom and PA systems have been limited. Analog transmissions, in which speech or data is converted directly into a varying electrical current, is suitable for local calls. However, once the call involves any significant distance, the necessary amplification of the analog signal can add so much noise that the received signal becomes unintelligible.

The Internet is a worldwide digital network and is made up of a large number of computer networks all linked together. Several million individual computers are connected through the computer networks. Anyone with access to one of the computers will have access to all of the other computers, in theory. TCP/IP (Transmission Control Protocol/Internet Protocol) is the set of rules that enables different types of computers and networks on the Internet to communicate with one another. TCP/IP was originally developed by the United States Department of Defense for computers using the UNIX operating system, but it is now used by every computer, regardless of operating system, on the Internet. TCP defines how data is transferred across the Internet to their destination. IP defines how data is divided into chunks, called packets, for transmission; it also determines the path each packet takes between computers. To be part of the Internet a computer, or other communication device, must have a unique Internet Protocol (IP) network address so that information can be correctly routed to and from the machine over the Internet.

Local Area Networks (LAN's) are collections of interconnected computers that can share data, applications, and resources, such as printers. Computers in a LAN are separated by distances of up to a few kilometers and are typically used in offices or across university campuses. A LAN enables the fast and effective transfer of information within a group of users and reduces operational costs. The most popular LAN protocol is called Ethernet, originally developed by Xerox in 1976, Ethernet is a widely implemented network from which the IEEE 802.3 standard for contention networks was developed. Ethernet uses a bus topology (configuration) and relies on the form of access known as CSMA/CD to regulate traffic on the bus. Network nodes are connected by coaxial cable (in either of two varieties, known as thin and thick) or by twisted-pair wiring. Thin Ethernet cabling is 5 millimeters (about 0.2 inch) in diameter and can connect network stations over a distance of 300 meters (about 1000 feet); thick Ethernet cabling is 1 centimeter (about 0.4 inch) in diameter and can connect stations up to 1000 meters (about 3300 feet) apart. Information on an Ethernet network is sent in variable-length frames containing delivery and control information plus up to 1500 bytes of data. The original Ethernet standard provides for baseband transmission at 10 megabits (10 million bits) per second. Most mid-size and large companies have LAN's in place within their current office buildings.

Telephones are devices that send and receive voice messages and data. Telephones convert speech and data into electrical energy, which can be sent great distances. All telephones are linked by complex switching systems called central offices or exchanges, which establish the pathway for the signals to travel. Today's automatic exchanges use a pair of computers, one running the program that provides the service, and the second monitoring the operation of the first, ready to take over in a few seconds in the event of an equipment failure. A large business will usually have its own switching machine called a Private Branch Exchange (PBX), with hundreds or possibly thousands of lines, all of which can be reached by dialing one number. The extension telephones connected to the large business's PBX are often identical to the simple single-line instruments used in residences.

A cellular telephone is designed to give the user maximum freedom of movement while using a telephone. A cellular telephone uses radio signals to communicate between the handset and a cellular antenna. The served area is divided into cells something like a honeycomb, and an antenna is placed within each cell and connected by telephone lines to one exchange devoted to cellular-telephone calls. This exchange connects cellular telephones to one another or transfers the call to a regular exchange if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna. Digital cellular phones are currently the most popular because the radio signals provide better reception and they are harder to intercept.

What is needed in the field is a communication system that can use a LAN that a business already has in place as the network for the communication system. The ideal system would be able to expand to include any network connected to the Internet. The ideal system would also provide a simple method for selecting the destination of analog messages and allow for dynamic addressing.

### SUMMARY OF THE INVENTION

A communications system with distributed intelligence that is easily expanded and highly fault tolerant. The system is capable of transmitting voice data over a digital network. The communications system comprises an input device for receiving the voice message, an audio adapter for converting the message into a digital format and placing the message on the network, a station adapter for taking the message off the network and converting it back to an analog signal, and an output device for playing the voice message. The input device receives the voice data and some destination data that determines one or more destinations for the message. The audio adapter receives the voice and destination data from the input device, converts the voice and destination data into a format that is suitable for transmission over the digital network and places the formatted data on the network. The station adapter monitors traffic on the network, receives digital data from the network that is addressed to the station adapter and converts the received data into an analog signal. The output device receives the analog signal from the station adapter and plays the analog signal over one or more speakers.

The system can include multiple station adapters and each station adapter can include multiple output devices. The preferred input device is a telephone and the preferred digital network is an Ethernet based network. Typical output devices include telephones, intercom boxes and zones of speakers. The voice and destination data from the input device may first goes through a private branch exchange before it is received by the audio adapter. The station adapter can include a transceiver and the digital data that is addressed to the station adapter can be transmitted from a cellular antenna to the station adapter.

The present system is ideally suited for use with an existing local area network. In the preferred embodiment, the audio adapter has the capabilities of the station adapter, the station adapter has the capabilities of audio adapter, the input and output devices have microphones and speakers and two way communications is enabled.

It is an object of the present invention to provide a dynamic communications system that can easily be added to an existing network.

It is a further object of the present invention to provide a robust communication system that is extremely fault tolerant.

### BRIEF DESCRIPTION OF THE DRAWINGS

The invention of the present application will be described in detail with reference to the accompanying drawing(s), given only by way of example, in which:

FIG. 1 shows an embodiment of the present communication system with three paging zones;

FIG. 2 shows an alternate embodiment of the present communications system;

FIG. 3 shows another embodiment of the present communications system;

FIG. 4 shows yet another embodiment of the present communications system;

FIG. 5 is a block diagram of an exemplary audio adapter; and,

FIG. 6 is a block diagram of an exemplary station adapter.

### DETAILED DESCRIPTION OF THE INVENTION

The present paging system is a distributed system, which benefits from not having any one piece of hardware, such as a central server, that can cause the entire system to go down. Each of the present communication devices is a self-contained unit with its own intelligence that allows the device to operate independently. Unlike centralized communication systems that rely on a central server to decode addresses and perform other required functions, there is no central server or other central device in the present paging system. After programming, the present communication devices monitor the network, decode addresses and send audio signals all on their own. The present devices are also able to handle specialized telephone features including caller ID, call forwarding, call waiting, voice mail, busy, speed dialing, emergency break-in, 911, call queuing, call parking, call transferring, and conference calling. In the preferred embodiment, the present devices are connected to an already existing computer network, such as an Ethernet. Once on the network, the present devices can be programmed via a computer that is also attached to the network. A software package with a browser interface is preferably used to guide an administrator through the set-up procedure. After the initial set-up, the computer can be removed from the network and the present paging devices will operate on their own. The present devices are also able to handle dynamic Internet Protocol (IP) addressing, meaning that a device may be moved to a new location where it is assigned a new IP address and the device will still function properly. The present system is ideally suited for using Local Area Networks (LAN's) that are already in place as the system's network.

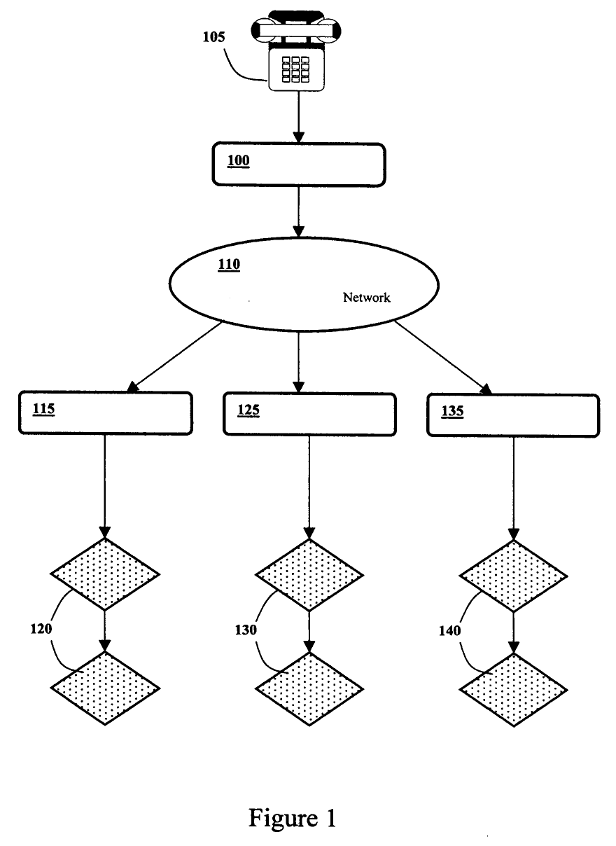

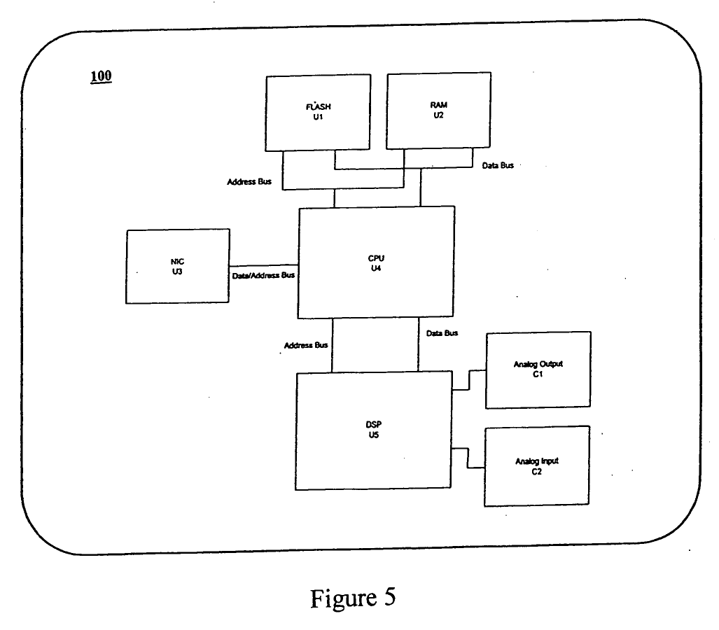

FIG. 1 shows the present distributed paging system set up with three paging zones 120,130 and 140. To use the present system a user picks up the receiver of telephone 105, dials the two digit dialing code for the desired zone and then speaks into the receiver. The paging system transmits the user's voice (audio signal) to the desired zone and plays the audio signal over the selected speakers. The present system also allows the user to select more than one zone, or all of the available zones, for playing an audio signal over. In the present system, the user may also use a dialing code of 99 in order to have their voice broadcast over all of the available speakers 120, 130 and 140. Telephone 105 is connected to paging device 100, which is called a network audio adapter. Audio adapter 100 receives audio signals, converts them digital signals, adds some destination information and sends the digital information over the network 110. A block diagram of an exemplary audio adapter is provided in FIG. 5. The network requirement for full duplex communications (speech going in both directions) is 144 Kbps. The requirement for half duplex communications (speech going on one direction) is 72 Kbps. Each of the receiving devices 115, 125 and 135 are called network station adapters. Station adapters 115, 125 and 135 listen to traffic over the network 110 to see if any of the traffic is intended for them. When a station adapter hears a message that is addressed to them, the station adapter grabs the message, converts the digital information back to an analog signal and plays the audio signal over their speakers. When the analog signal is digitized, samples of the signal's strength are taken at regular intervals, 8000 samples per second for example. Each sample is converted into digital form; a series of 1's and 0's. Digital transmission systems, such as the Internet, are less sensitive to interfering noise than are analog systems. The digital signal is converted by the station adapters to a form that the ear cannot distinguish from the original signal. The audio signals are preferably amplified prior to being played over the speaker(s). The present system can support over one hundred output devices or paging zones.

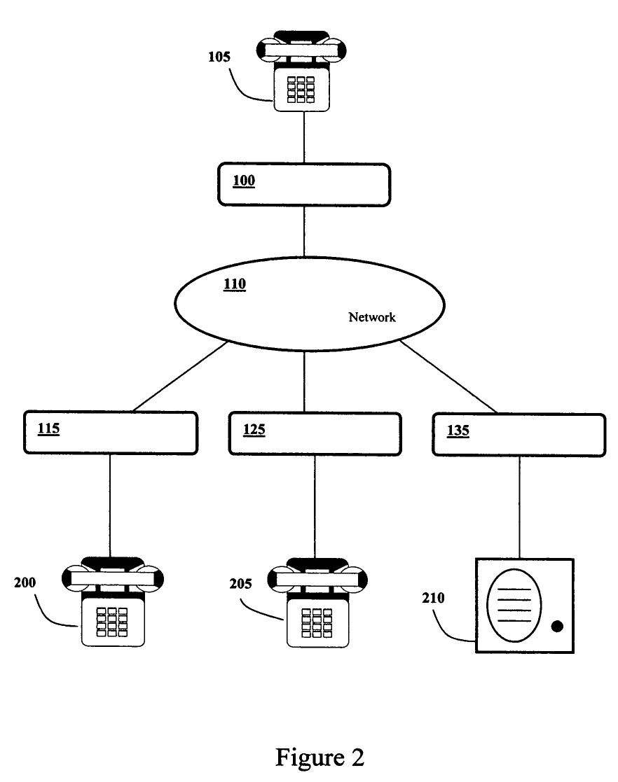

FIG. 2 shows an embodiment of the present system that outputs audio signals to telephones 200 and 205, and to intercom 210. Station adapter 115 and 125 each have on-board ring generation, which will cause the telephones 200 and 205 to ring when a message is address to them. In this embodiment, the station adapters 115,125 and 135 receive digital information, convert the audio portion to an analog signal and forward the analog signal to a destination speaker. However, station adapters 115, 125 and 135 also have the capabilities of audio adapter 100, meaning that the station adapters can receive audio signals, from telephones 200 and 205 and intercom 210, convert the audio signals to a digital format, add destination information and send the digital information over the network 110. Further, audio adapter 100 also has the capabilities of the station adapters 115,125 and 135, meaning that audio adapter 100 can receive digital information from network 110, convert the audio portion of the message to analog and send the audio signal to the speaker of telephone 105. FIG. 2 also illustrates the automatic destination ability of the present system, wherein a push to talk button provided on intercom 210 automatically sends any received audio signal to a predetermined destination. In FIG. 2, the audio signal from intercom 210 is automatically sent to telephone 105.

Station adapters 115 and 125 also have dynamic IP addressing capabilities, meaning they can be moved to new locations, assigned new IP address and still function properly. The present intelligent adapters know the dialing code(s) (telephone number(s)) that they are responsible for and paging operation are allowed to carry on normally regardless of the new IP address. In other words, dynamic IP addressing is transparent to the user. The present paging system uses a special protocol called a Multicast Telephony Protocol (MTP) that allows dynamic IP addressing. The MTP protocol requires that messages from audio adapters be broadcast to all station adapters. The intelligent station adapters then monitor each message to determine if the message is intended for them. It is worth noting that dynamic addressing is normally handled by a central server in most communications systems. However, the present communications system does not use a central server. In fact, there are no servers at all used in the present system. This distributed design provides a very robust communications system that is not easily degraded. Such a system is ideal for applications such as homeland security.

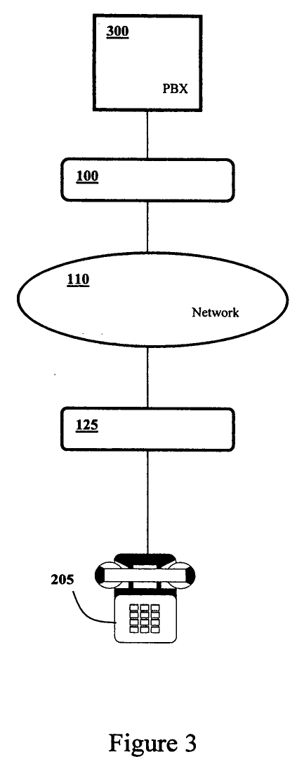

FIG. 3 illustrates the flexibility of the present system. In the embodiment of FIG. 3, a company's private branch exchange (PBX) 300 is connect to the audio adapter 100. This set up allows thousands of company employees to take advantage of the present communications system. Each employee can use their own telephone to send an audio message to practically anywhere else in the world via network 110, station adapter 125 and telephone 205.

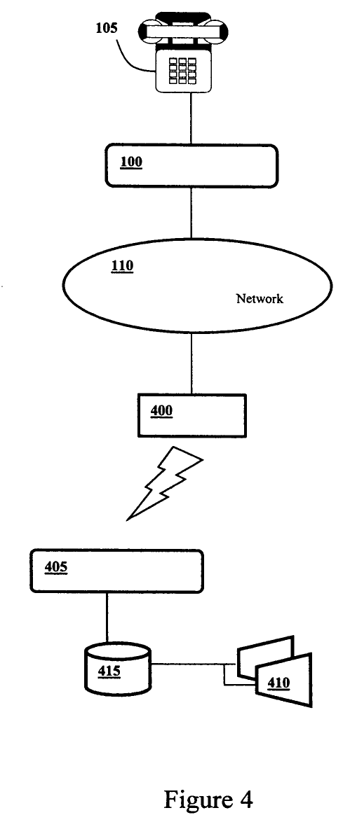

FIG. 4 illustrates an additional feature of the present distributed system. Sometimes it is not possible to have all locations physically connected to a computer network or to the public telephone systems. Such locations include the inside of an airplane or boat and remote locations on land that simply do not have telephone service and are not connected to a computer network. In this case, the present system incorporates radio transceivers so that communications can take place between the airplane, boat or remote location and a parent organization. In FIG. 4, a user takes telephone 105 of hook, dials the desired dialing code and speaks into the telephone 105. Audio adapter 100 uses the present MTP protocol to broadcast the message over network 110. While other station adapters receive the message over a wired network, station adapter 405 receives the message via radio waves from transceiver 400. If adapter 405 is the desired destination then adapter 405 plays the audio signal over speakers 410. Thus, the present system allows audio signals to be sent to almost any location. Further, with the use of one of the present intelligent adapters and a microphone, the present system also allows audio signals to be received from almost any location.

FIG. 5 is an exemplary block diagram of audio adapter 100, which provides an interface between an analog audio source, such as a telephone, and an Ethernet based network. The major functional blocks are the central processing unit U4, which along with the Random Access Memory (RAM) U2 provides execution of program instructions that are stored in non-volatile program storage (FLASH) U1. Telephony Digital Signal Processor (DSP) U5 provides a special computational element for processing audio signals in a digital domain. DSP U5 is responsible for encoding and decoding analog audio signals to and from a format suitable for transport across a digital network. Audio Adapter 100 can receive analog signals and transfer them into digital signals. Audio Adapter 100 can also receive digital signals and transfer them into analog signals. Analog Input circuit C2 conditions input audio signals so the audio signals can be processed by the DSP U5. Analog Output circuit C1 conditions output audio signals from the DSP Us, as appropriate, for playback via external equipment, such as the speaker on a telephone. CPU U4 takes processed data from the DSP U5 and further processes it so the data can be sent to other adapters connected to the network. The data is placed on the network via Network Integrated circuit (NIC) U3.

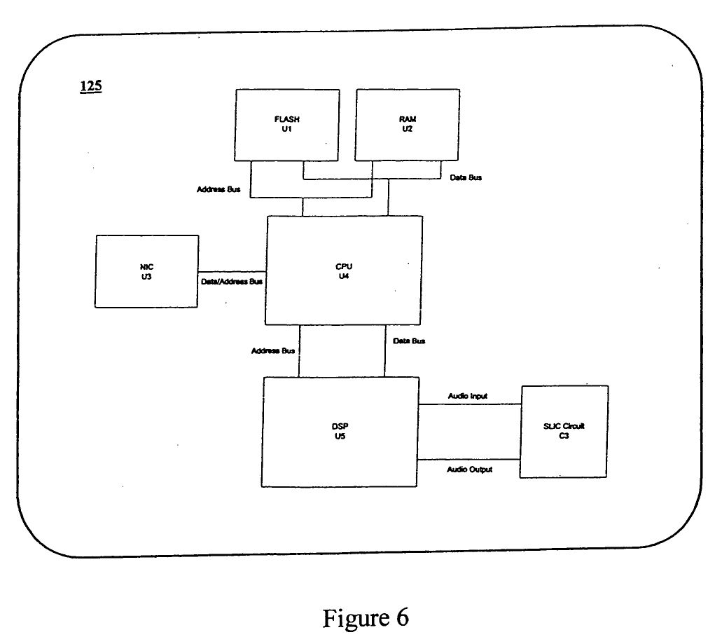

FIG. 6 is a block diagram of an exemplary station adapter 125, which provides an interface between a digital network and an analog signal output device, such as a speaker or telephone. The major functional blocks in the station adapter 125 are generally the same as the major functional blocks in the audio adapter 100. The station adapter 125 is primarily used to receive digital Information and convert the information into an analog signal. However, the station adapter 125 is also capable of receiving analog signals, transferring the analog signals into digital information and sending the information over a network. CPU U4 takes network data from the NIC U3 and further processes the network data so the data can be sent to the DSP U5. The DSP U5 further processes the received data to regenerate an analog signal, which is output via SLIC circuit C3. It should be noted that the major difference between the audio adapter 100 and the station adapter 125 is the analog interface; C1 & C2 in FIG. 5 and C3 In FIG. 6. A generic version of the present adapters can be used a trunk adapter, meaning that the adapter can be used with multiple different analog interfaces. Thus the present adapter can be used with almost any input or output device. Audio In is preferably at 600 Ohms and Audio Out is preferably 32 Ohms for the analog interfaces. In the preferred embodiment, both the audio and station adapters 100 & 125 have power supplies of 24 V DC. Preferable physical features of the adapters include metal enclosures that are rack mountable.

The present intelligent adapters preferably use 32 bit processors to handle all of the information that each adapter must process. This distributed intelligence allows the adapters to know each dialing code (telephone number) that they have. The adapters are also able to tell other adapters which telephone numbers they have. In larger systems, a network trunk adapter is preferably used. The trunk adapter acts in a manner similar to a station adapter and can also act as gateway to a PBX.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

1. A communications system with distributed intelligence that is easily expanded and highly fault tolerant, wherein the system is capable of transmitting voice data over a digital network, the communications system comprising:
an input device, the input device capable of receiving the voice data and destination data, wherein the destination data determines one or more destinations for the voice data;
an audio adapter, the audio adapter capable of receiving the voice and destination data from the input device, converting the voice and destination data into a format that is suitable for transmission over the digital network and placing the formatted data on the network;
a station adapter, the station adapter capable of monitoring traffic on the network, receiving digital data from the network that is addressed to the station adapter and converting the received data into an analog signal; and, an output device, the output device capable of receiving the analog signal from the station adapter and playing the analog signal over one or more speakers.

2. The system of claim 1, wherein the system includes multiple station adapters and each station adapter is connected to multiple output devices.

3. The system of claim 1, wherein the input device is a telephone and the digital network is an Ethernet based network.

4. The system of claim 1, wherein the audio adapter has dynamic IP addressing and the output device is a telephone.

5. The system of claim 1, wherein the station adapter has dynamic IP addressing and the output device is an intercom box.

6. The system of claim 1, wherein the voice and destination data from the input device first goes through a private branch exchange before it is received by the audio adapter.

7. The system of claim 1, wherein the station adapter further comprises a transceiver and the digital data that is addressed to the station adapter is transmitted from a cellular antenna before it is received by the station adapter.

8. The system of claim 1, wherein the system is adapted to be used with an existing local area network.

9. The system of claim 1, wherein the audio adapter also has the capabilities of the station adapter, the station adapter also has the capabilities of audio adapter, the input device also has the capabilities of the output device and the output device also has the capabilities of the input device so that two way communications can take place between the input device and the output device.

10. A communications system with distributed intelligence that is easily expanded and highly fault tolerant, wherein the system is capable of transmitting voice data over a digital network, the communications system comprising:
an input device, the input device capable of receiving the voice data and destination data, wherein the destination data determines one or more destinations for the voice data;
an audio adapter, the audio adapter capable of receiving the voice and destination data from the input device, converting the voice and destination data into a format that is suitable for transmission over a digital network and placing the formatted data on the network;
a first transceiver, wherein the first transceiver is capable of receiving the formatted data from the network and wirelessly transmitting the data;
a station adapter, wherein the station adapter includes a second transceiver, the second transceiver capable of receiving the wirelessly transmitted data and converting the received data into an analog signal; and, an output device, the output device capable of receiving the analog signal from the station adapter and playing the analog signal over one or more speakers.

11. The system of claim 10, wherein the system includes multiple station adapters and multiple output devices.

12. The system of claim 10, wherein the input device is a telephone and the digital network is an Ethernet based network.

13. The system of claim 10, wherein the output device is a telephone.

14. The system of claim 10, wherein the output device is an intercom box.

15. The system of claim 10, wherein the voice and destination data from the input device first goes through a private branch exchange before it is received by the audio adapter.

16. The system of claim 10, wherein multiple transceivers are capable of receiving the formatted data from the network.

17. The system of claim 10, wherein the system is adapted to be used with an existing local area network.

18. The system of claim 10, wherein the audio adapter also has the capabilities of the station adapter, the station adapter also has the capabilities of audio adapter, the input device also has the capabilities of the output device and the output device also has the capabilities of the input device so that two way communications can take place between the input device and the output device.

19. The system of claim 1, wherein the audio adapter includes a first analog interface and the first analog interface is capable of being replaced by a second analog interface.

20. The system of claim 10, wherein the station adapter includes a first analog interface and the first analog interface is capable of being replaced with a second analog interface.
